(19) United States
(12) Patent Application Publication
(10) Pub. No.: US 2024/0095775 A1
(43) Pub. Date: Mar. 21, 2024

(54) PRODUCT-DESIGN GENERATION SUPPORT DEVICE, PRODUCT-DESIGN GENERATION SUPPORT METHOD, AND PROGRAM STORAGE MEDIUM

(71) Applicant: NEC Corporation, Minato-ku, Tokyo (JP)

(72) Inventors: Makoto TAKAMOTO, Tokyo (JP); Daniel ONORO RUBIO, Heidelberg (DE)

(73) Assignee: NEC Corporation, Minato-ku, Tokyo (JP)

(21) Appl. No.: 18/274,650

(22) PCT Filed: Mar. 31, 2021
(86) PCT No.: PCT/JP2021/013821

§ 371 Date: Jul. 27, 2023

(51) Int. Cl. G06Q 30/0242; G06V 10/762; G06V 40/18

(52) U.S. Cl. CPC G06Q 30/0246; G06V 10/762; G06V 40/18; G06V 2201/07

(57) ABSTRACT

In order to generate and present information that is effective for preparing and determining a product design, a product-design generation support device according to the present invention is provided with an acquisition unit, a classification unit, and an output unit. The acquisition unit acquires design information representing a target design for a target product, as well as gaze information of a plurality of target persons in relation to the target design. The classification unit classifies the plurality of target persons into a plurality of groups on the basis of the acquired design information and gaze information. The output unit outputs the result of the classification.

### TECHNICAL FIELD

The present invention relates to a technique for providing information about how a product design looks.

### BACKGROUND ART

When a design of a new product or a renewed product is determined, questionnaire answers or a result of a monitor survey from product purchasers regarding a design of a product collected before that time may be referred to.

PTL 1 (JP 2017-41123 A) discloses a technique for obtaining knowledge of how to promote a product. The system disclosed in PTL 1 outputs information indicating a problem point of a product (for example, information about whether to improve the package of the product or to improve the brand power of the product) based on a numerical value indicating the amount of a line of sight to a target object (product) and a numerical value indicating an interest in the target object.

### CITATION LIST

### Patent Literature

PTL 1: JP 2017-41123 A

### SUMMARY OF INVENTION

### Technical Problem

The information about the product design obtained from the questionnaire answers and the result of the monitor survey as described above is often a simple impression such as good feeling about a bright image, not liking the combination of colors, and feeling that a character's drawing is cute. For this reason, it may be difficult for the product developer or the designer to determine which part of the product design is to be focused on to prepare (generate) the product design from the questionnaire answers and the result of the monitor survey.

Furthermore, in a case where the information output from the system described in PTL 1 is referred to, the product developer or the designer can find whether there is a point to be improved in the package of the product. However, in the case where there is a point to be improved in the package of the product, the above-described information output from the system is information indicating that there is a point to be improved, and it is thus considered that it is difficult for the product developer or the designer to determine which part of the product design is to be focused on to prepare (generate) the product design even by referring to the information.

The present invention has been devised in order to solve the aforementioned problems. That is, a main object of the present invention is to provide a technology capable of supporting preparation (generation) of a product design.

### Solution to Problem

In order to achieve the above object, a product-design generation support device according to the present invention includes, as one aspect, an acquisition unit that acquires design information representing a target design for a target product, as well as gaze information of a plurality of target persons in relation to the target design, a classification unit that classifies the plurality of target persons into a plurality of groups based on the design information and the gaze information acquired, and an output unit that outputs a result of the classification.

Also, a product-design generation support method according to the present invention includes, as one aspect, by means of a computer, acquiring design information representing a target design for a target product, as well as gaze information of a plurality of target persons in relation to the target design, classifying the plurality of target persons into a plurality of groups based on the design information and the gaze information acquired, and outputting a result of the classification.

Further, a program storage medium according to the present invention stores a computer program that causes a computer to execute, as one aspect, processing of acquiring design information representing a target design for a target product, as well as gaze information of a plurality of target persons in relation to the target design, processing of classifying the plurality of target persons into a plurality of groups based on the design information and the gaze information acquired, and processing of outputting a result of the classification.

### Advantageous Effects of Invention

According to the present invention, it is possible to provide a technology capable of suitably supporting preparation (generation) of a product design.

### BRIEF DESCRIPTION OF DRAWINGS

FIG. 1 is a diagram illustrating a configuration of a product-design generation support device according to a first example embodiment.

FIG. 2 is a diagram illustrating design elements.

FIG. 3 is a diagram illustrating an example of a venue survey.

FIG. 4 is a diagram illustrating a gaze trajectory and a gaze fixing time.

FIG. 5 is a diagram further illustrating the gaze trajectory and the gaze fixing time.

FIG. 6 is a diagram illustrating an example of a graph (knowledge graph).

FIG. 7 is a diagram illustrating a display example representing cluster information.

FIG. 8 is a flowchart illustrating an example of the operation of the product-design generation support device according to the first example embodiment.

FIG. 9 is a diagram illustrating an example of the graph (knowledge graph) used in the second example embodiment.

FIG. 10 is a diagram illustrating a display example of a classification reason.

FIG. 11 is a diagram illustrating an example of the graph (knowledge graph) used in the fourth example embodiment.

FIG. 12 is a diagram illustrating one of other example embodiments.

FIG. 13 is a diagram illustrating a configuration of a product-design generation support device according to one of the other example embodiments.

FIG. 14 is a flowchart illustrating an example of the operation of the product-design generation support device according to the one of the other example embodiments.

### EXAMPLE EMBODIMENT

Hereinbelow, example embodiments of the present invention will be described with reference to the drawings.

### First Example Embodiment

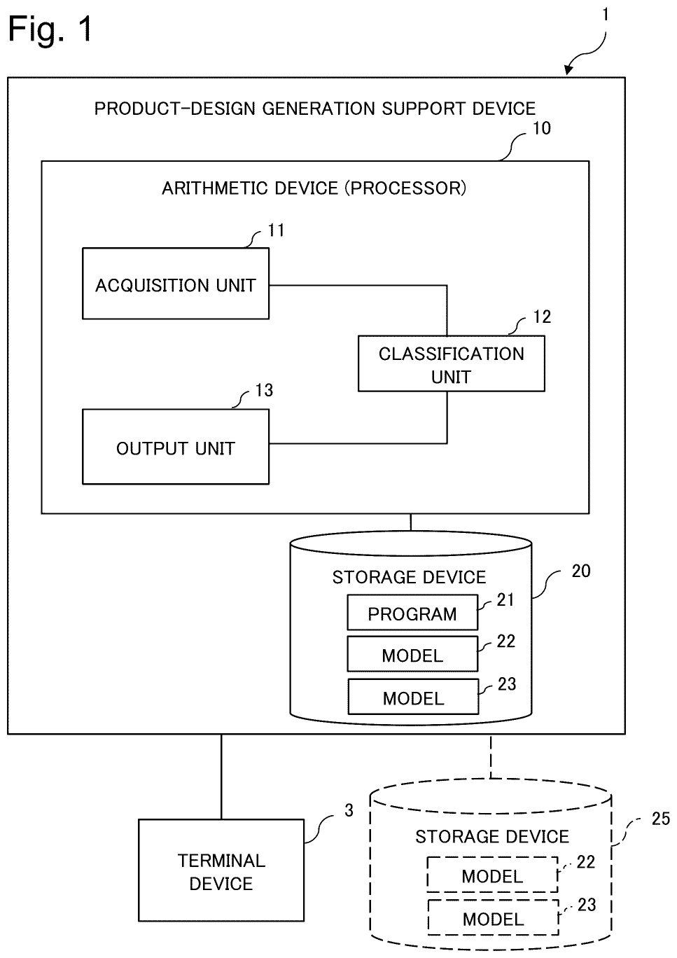

FIG. 1 is a diagram illustrating a configuration of a product-design generation support device according to a first example embodiment of the present invention. A product-design generation support device 1 according to the first example embodiment has a function of providing information about how a design of a target product looks. In the following description, the product-design generation support device is abbreviated and also referred to as a support device.

Here, the target product is a product targeted for a survey whose design is intended to be surveyed. A product includes not only a tangible product such as a food, a toy, a sundry good, furniture, a home appliance, and clothing, but also an intangible product such as a service and information. Here, the product is a tangible product, and the design of the product is a shape, a pattern, a color, a combination of these, or the like of the product. In addition, some products have a form in which the contents such as foods, toys, and sundry goods are housed in a package. In the case of such a product including a package, the design of the product that the support device 1 targets may be a design of only one of the package and the contents of the package, or may be a design of each of or a combination of the package and the contents. Although the support device 1 can support any of such designs, in the first example embodiment, the configuration of the support device 1 will be described using a design of a package of a product (hereinbelow, also referred to as a package design) as an example.

The support device 1 is a computer (for example, a server or the like disposed in a data center), and can be connected to a terminal device 3 via, for example, a wired or wireless information communication network as illustrated in FIG. 1. The terminal device 3 is a personal computer (PC), a tablet, a smartphone, a wearable terminal, or the like, and for example, design information for a target product and gaze information of a plurality of persons in relation to the target product are transmitted from the terminal device 3 to the support device 1.

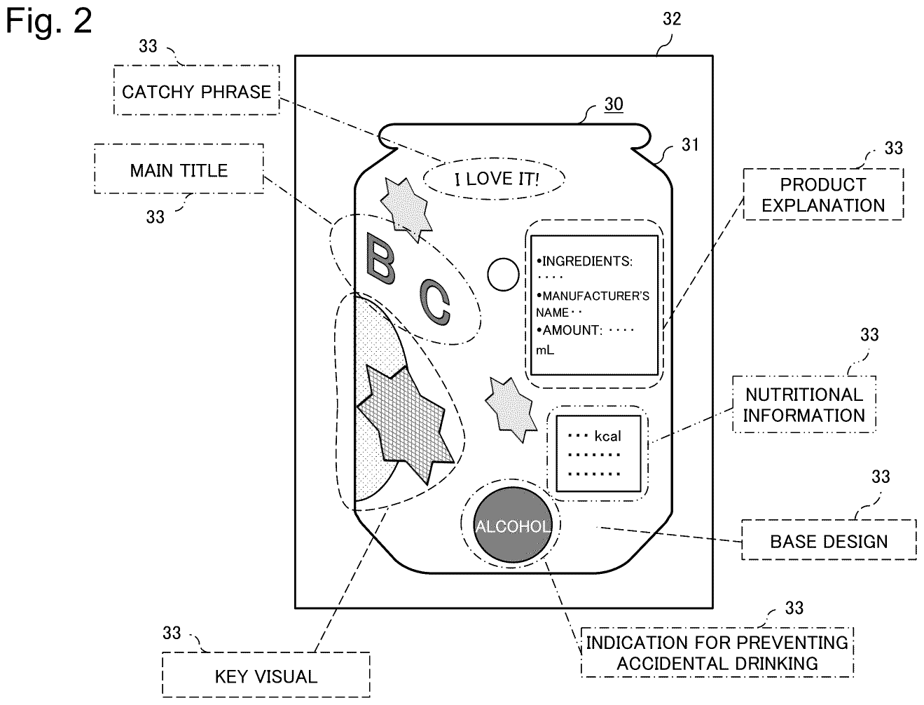

The design information is information representing a design for a target product. In the first example embodiment, the design information includes a design image 32 as illustrated in FIG. 2. The design image 32 is an image representing a product design, such as a photographed image obtained by photographing the product design or an illustration image in which the product design is drawn.

Furthermore, in the first example embodiment, the design information includes not only the design image 32 but also explanatory information 33 for design elements. The design elements are elements constituting a design, and for example, in a package design of a canned beverage as illustrated in FIG. 2, the design elements include a main title, a catchy phrase, a key visual, a base design, a product explanation (ingredient names, a manufacturer's name, amount, alcohol content, and the like), nutritional information, and an indication for preventing accidental drinking. Although not illustrated in FIG. 2, the design elements also include a material mark (aluminum, steel, or the like) for a can, a caution (“Put empty cans in a trash box.”, “Wait until you are 20 to drink alcohol.”, and the like), a two-dimensional code, an indication for a taste, an indication for a beverage kind, an indication for a production area of a main ingredient, and the like. The design elements further include information about the characteristic shape of the package, information about the material for the package, and the like.

The explanatory information 33 for design elements includes the name representing the design element as described above (for example, a main title and a key visual), information representing the position of the design element in the design image 32, and information related to the design. The information related to the design is, for example, information representing the arrangement position in the package, size information (for example, the ratio (occupancy) of the occupied area to the surface area of the entire package, and the font size of characters), information representing a color type, and the like.

In the first example embodiment, the design information for the target product is transmitted from the terminal device 3 to the support device 1.

The gaze information of the person is information related to the gaze of the person, and examples of the gaze information include a gaze trajectory and a gaze fixing time. The gaze trajectory is the movement of the gaze when the person is looking at the design for the target product. Also, the gaze fixing information is a time during which the gaze is fixed on a portion on which the gaze is fixed when the person is looking at the design for the target product. Such gaze information can be acquired, for example, at a venue (survey venue) where a venue survey (central location test (CLT)) on the design for the target product is conducted. The venue survey is a survey method in which survey target persons (monitors) are gathered in a preset venue (survey venue) and a questionnaire (including an interview) is conducted. For example, in a venue survey on a product design, the monitors are asked about intention to purchase regarding whether they want to purchase the product by looking at the product design. In addition, the monitors are requested to give an opinion (comment) on the product design.

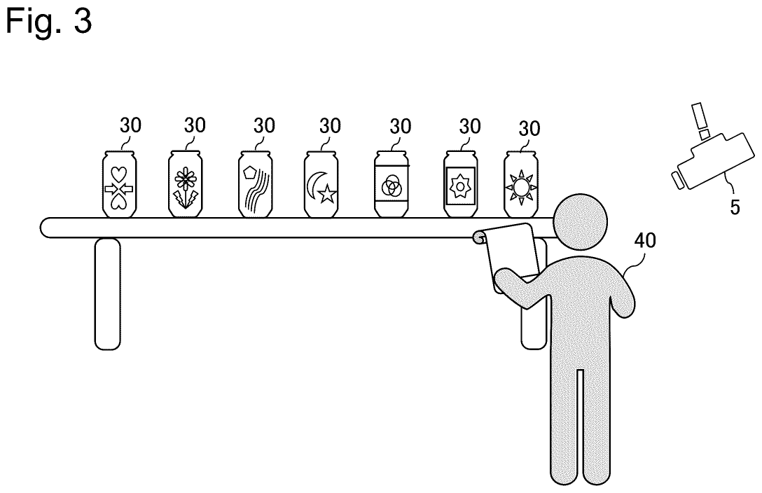

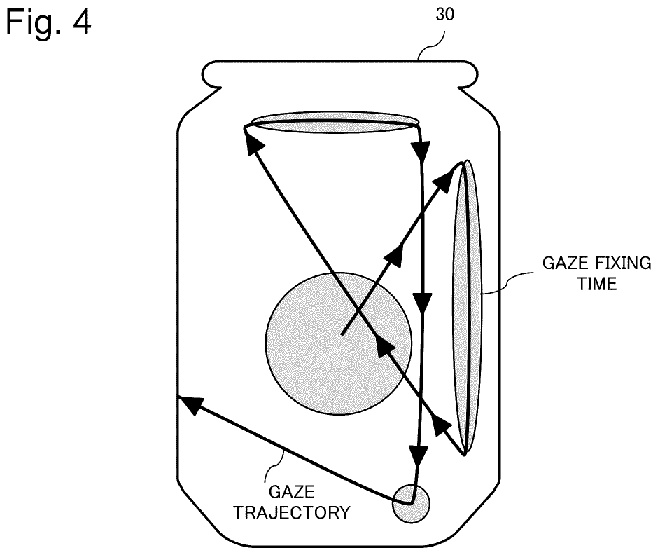

FIG. 3 is a diagram illustrating an example of a state of a survey venue where a venue survey on a package design for a product 30 is being conducted. In the survey venue, for example, as illustrated in FIG. 3, a plurality of products 30 having different package designs are arranged. At least the face of a monitor 40 looking at the products 30 arranged in this manner is photographed by a photographing device 5. By analyzing the photographed image (or shot moving image) obtained by the photographing, information regarding the gaze such as how the monitor 40 moves the gaze to look at the package design for each of the products 30 is obtained. FIG. 4 is a diagram illustrating, as an image, information regarding the gaze acquired by analysis of the photographed image. In the example of FIG. 4, a line representing the gaze trajectory of the target person in relation to the product 30 and graphic images representing the gaze fixing time are superimposed on the image of the package design of the product 30. The graphic representing the gaze fixing time is located at a portion on which the gaze is fixed, and has an area in accordance with the gaze fixing time. Also, the target person here is a person who is looking at the product 30, and, as an example, is the target person (monitor) of the venue survey. Note that, in the example of FIG. 4, the gaze fixing time is represented as a graphic image, but the gaze fixing time may not necessarily be represented as a graphic image. For example, the gaze fixing time may be a time (number of seconds) represented as a number.

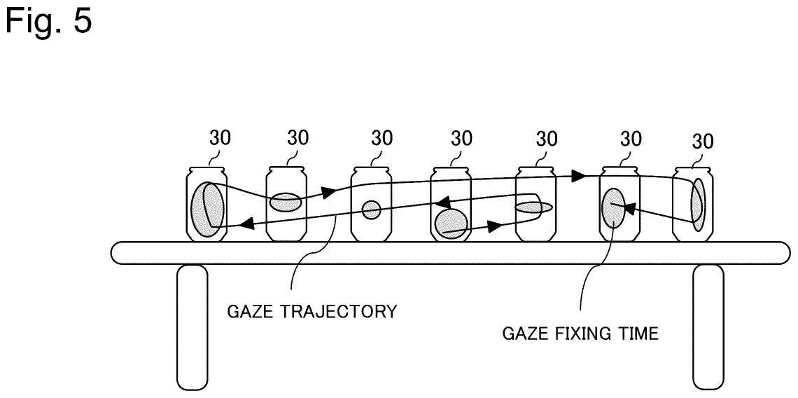

Furthermore, by analysis of the photographed image, information regarding the gaze such as the order in which the monitor 40 has looked at the plurality of products 30 arranged and where the gaze is fixed is also obtained. FIG. 5 is a diagram illustrating, as an image, information regarding the gaze acquired by analysis of the photographed image for the plurality of products 30 arranged. In the example of FIG. 5, as well as that of FIG. 4, a line representing the gaze trajectory and graphic images representing the gaze fixing time are superimposed on the image of the package designs of the plurality of products 30 arranged.

The gaze information further includes a visual recognition time, the number of times of visual recognition, a visual recognition ratio, and the like for the product. The visual recognition time is a time during which the monitors 40 (target persons) are looking at a certain product 30. The number of times of visual recognition is the number of times the monitors 40 have looked at a certain product 30 in a situation where a plurality of products 30 are arranged. The visual recognition ratio is a ratio of a time during which the monitors 40 are looking at a certain target product to a time during which the monitors 40 are looking at the plurality of products 30 arranged, or a ratio of the number of times the monitors 40 have looked at a certain product 30 to the total number of times the monitors 40 have looked at the plurality of products 30. Note that prototypes, comparative products, and the like that are not actually sold as products may be arranged in the survey venue or the like for the venue survey. Here, such prototypes, comparative products, and the like are also referred to as products.

In the first example embodiment, one of the plurality of products 30 arranged in the survey venue is set as a product targeted for a survey (that is, the target product), and the gaze information of the plurality of target persons (monitors 40) in relation to the product targeted for a survey (target product) is transmitted from the terminal device 3 to the support device 1. In the following description, the target product (product targeted for a survey) is also referred to as a target product 30S in order to be distinguished from the different products 30. Also, the design for the target product 30S is also referred to as a target design. Also, the gaze information transmitted by the terminal device 3 may be information obtained by analysis of a photographed image by the terminal device 3, or may be information obtained by analysis of a photographed image by a different computer device from the terminal device 3 and acquired by the terminal device 3.

As illustrated in FIG. 1, the support device 1 according to the first example embodiment includes an arithmetic device 10 and a storage device 20. The storage device 20 has a configuration of storing various data and a computer program (hereinbelow, also referred to as a program) 21 that controls the operation of the support device 1, and includes, for example, a storage medium such as a hard disk device and a semiconductor memory. The number of storage devices included in the support device 1 is not limited to one, and a plurality of types of storage devices may be included in the support device 1. In this case, the plurality of storage devices are collectively referred to as the storage device 20.

In the first example embodiment, the storage device 20 further stores models 22 and 23 used by the arithmetic device 10. The model 22 is a model that vectorizes nodes and edges of a graph (also referred to as a knowledge graph) using graph artificial intelligence (AI) technology. The model 23 is a clustering model that classifies a plurality of pieces of data into a plurality of groups (hereinbelow, also referred to as clusters), and for example, a non-hierarchical clustering method is used.

Note that the support device 1 may be connected to an external storage device 25 as indicated by the dotted line in FIG. 1, and the models 22 and 23 may be stored in the storage device 25 instead of the built-in storage device 20. In this case, the support device 1 can use the models 22 and 23 by communicating with the storage device 25 in a wired or wireless manner.

The arithmetic device 10 includes, for example, a processor such as a central processing unit (CPU) and a graphics processing unit (GPU). The arithmetic device 10 can have various functions when the processor executes the program 21 stored in the storage device 20. In the first example embodiment, the arithmetic device 10 includes an acquisition unit 11, a classification unit 12, and an output unit 13 as functional units.

That is, the acquisition unit 11 acquires the design information for the target product, as well as the gaze information of the plurality of target persons (monitors 40) that have looked at the target design for the target product, transmitted from the terminal device 3. The gaze information acquired by the acquisition unit 11 is information regarding the gaze acquired by analysis of the photographed image by the photographing device 5 as described above, and includes, for example, at least one of the gaze trajectory and the gaze fixing time.

In the above example, the acquisition unit 11 acquires the gaze information from the terminal device 3. Alternatively, for example, the terminal device 3 may transmit a photographed image before being analyzed to the support device 1, the computer (server) constituting the support device 1 may generate the gaze information by analyzing the photographed image received from the terminal device 3, and the acquisition unit 11 may acquire the generated gaze information. Also, the design information and the person information acquired by the acquisition unit 11 are stored in the storage device 20.

The classification unit 12 classifies the plurality of target persons into a plurality of groups (clusters) based on the design information and the gaze information acquired by the acquisition unit 11. In the first example embodiment, the classification of the target persons by the classification unit 12 is executed using the models 22 and 23.

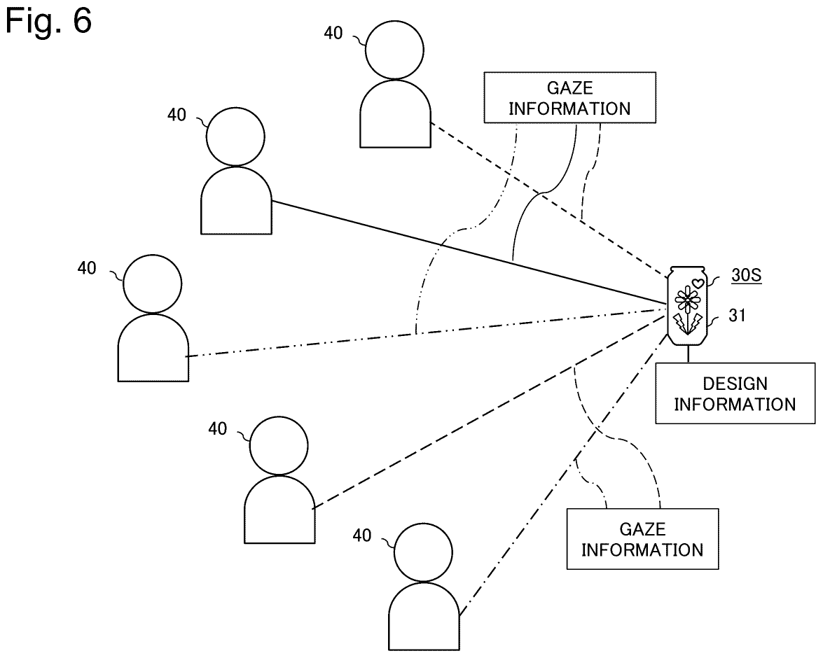

For example, the classification unit 12 first generates a graph (for example, a knowledge graph) as illustrated in FIG. 6 using the design information and the gaze information of the persons acquired by the acquisition unit 11. The generated graph is a graph in which a design 31 of the target product 30S and the target persons (monitors 40) are set as nodes, and pieces of the gaze information are set as edges.

Then, the classification unit 12 vectorizes the nodes and the edges in the graph using the model 22 by means of the graph AI technology. That is, information regarding the nodes and the edges in the graph is converted into feature vectors using the model 22.

Further, the classification unit 12 classifies the plurality of target persons into a plurality of clusters based on the feature vectors representing the nodes and the model 23 for clustering. That is, the model 23 is a model that classifies a plurality of target persons into a plurality of clusters (groups) using feature values of the plurality of target persons (monitors 40) based on the gaze information.

Specific examples of the cluster that each of the monitors 40 is classified as by the classification unit 12 include a cluster of persons who have looked at the title longer than the key visual (19% of all the monitors), a cluster of persons who have looked at the key visual first (24% of all the monitors), and a cluster of persons who have scanned the entirety (7% of all the monitors). Such cluster information is stored in the storage device 20.

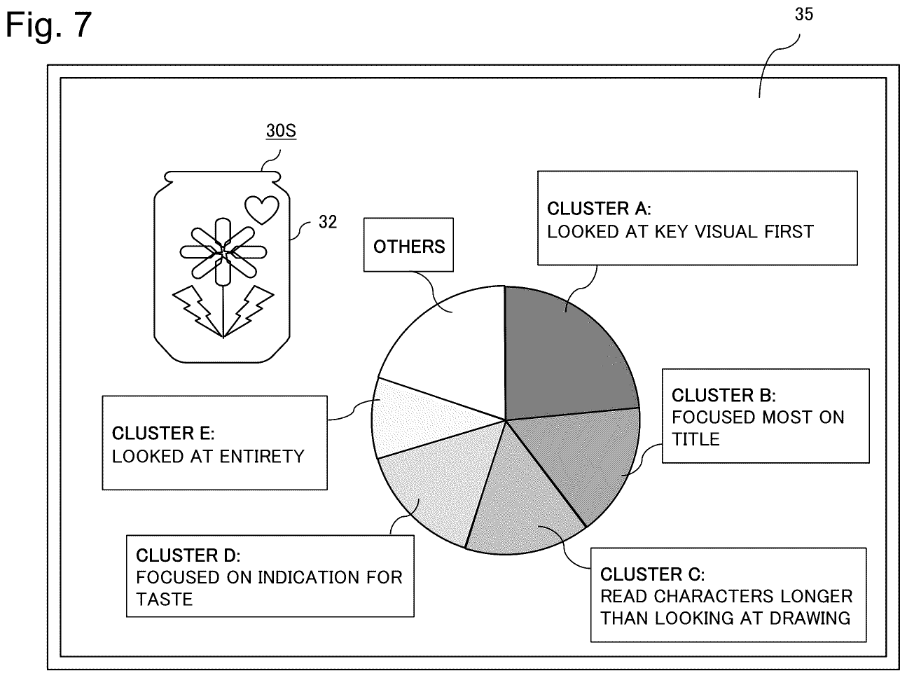

The output unit 13 outputs the result of the classification performed by the classification unit 12. For example, the output unit 13 outputs cluster information representing clusters as the result of the classification. An example of the cluster information includes information including, for each cluster, cluster identification information for identifying the cluster, information representing gaze information characteristic of the cluster, and, for example, information about a ratio of persons classified as the cluster to all the monitors. Such cluster information is transmitted to the terminal device 3, for example, and is displayed on a display device by the display control operation of the terminal device 3. FIG. 7 is a diagram illustrating a display example of the display device representing the result of the classification of the target persons. In the example of FIG. 7, the design image 32 of the target product 30S is displayed, and cluster information obtained by classifying (clustering) the target persons who have looked at the design of the target product 30S based on the gaze information is displayed using a graph.

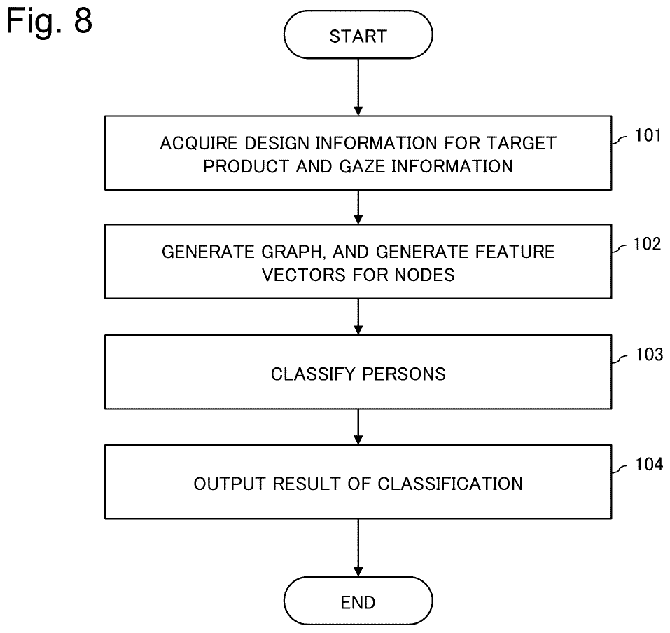

The support device 1 according to the first example embodiment has the above-described configuration. Hereinbelow, an example of the operation of classifying (clustering) the target persons in relation to the design of the target product 30S in the arithmetic device 10 of the support device 1 will be described with reference to FIG. 8. FIG. 8 is a flowchart illustrating an example of the operation of classifying the target persons in relation to the design of the target product 30S in the arithmetic device 10.

First, for example, the acquisition unit 11 of the arithmetic device 10 acquires design information for the target product 30S and gaze information of the target persons (monitors 40) in relation to the design 31 of the target product 30S transmitted from the terminal device 3 (step 101). Subsequently, the classification unit 12 uses the acquired design information and gaze information of the persons to generate a graph in which the design and the persons are set as nodes and pieces of the gaze information are set as edges. Furthermore, the classification unit 12 generates feature vectors for the nodes and the edges in the graph using the model 22 (step 102).

Subsequently, the classification unit 12 classifies the plurality of target persons into a plurality of clusters using the feature vectors representing the nodes and the model 23 (step 103). Then, the output unit 13 outputs cluster information as the result of the classification of the target persons (step 104). Note that the arithmetic device 10 can acquire the cluster information for the target persons for each of the plurality of products 30 by sequentially substituting a different product 30 for the target product 30S and performing the similar operation to that described above, for example.

The support device 1 according to the first example embodiment has a configuration of classifying the target persons using the gaze information and outputting the classification result as described above in relation to the design 31 for the target product 30S. By using the information provided by the support device 1, a product developer, a designer, or the like can easily determine which part of the product design is to be focused on to prepare (generate) the product design. In this manner, by generating and presenting information that is effective for preparing and determining a product design, the support device 1 achieves an effect of suitably supporting preparation (generation) of the product design.

Also, in particular, since the support device 1 uses the gaze information as described above instead of a simple impression received by the product purchaser or the monitor, it is possible to provide the gaze information, which is information that has the scientific basis, as information about how the design of the target product looks.

### Second Example Embodiment

Hereinbelow, a second example embodiment of the present invention will be described. Note that, in the description of the second example embodiment, the same reference signs are given to the same components as those of the product-design generation support device (support device) 1 according to the first example embodiment, and redundant description of the common components will be omitted.

The support device 1 according to the second example embodiment also uses opinion information of the target persons for the classification of the target persons (monitors 40). The opinion information is information representing an opinion of the monitor 40 on the design 31 of the target product 30S obtained by, for example, a questionnaire in a case where a survey such as a venue survey is conducted on the product design. Specifically, the opinion information includes an opinion regarding whether one wants to purchase the target product 30S by looking at the target product 30S (in the following description, it is also referred to as intention to purchase), a text representing a comment on the design 31 of the target product 30S, and the like.

That is, in the second example embodiment, the acquisition unit 11 of the arithmetic device 10 acquires the opinion information of the target persons (monitors 40) in addition to the design information and the gaze information of the target persons (monitors 40) described in the first example embodiment. Note that the opinion information is not limited to those described above as long as it is information representing the opinion of the monitor on the product design.

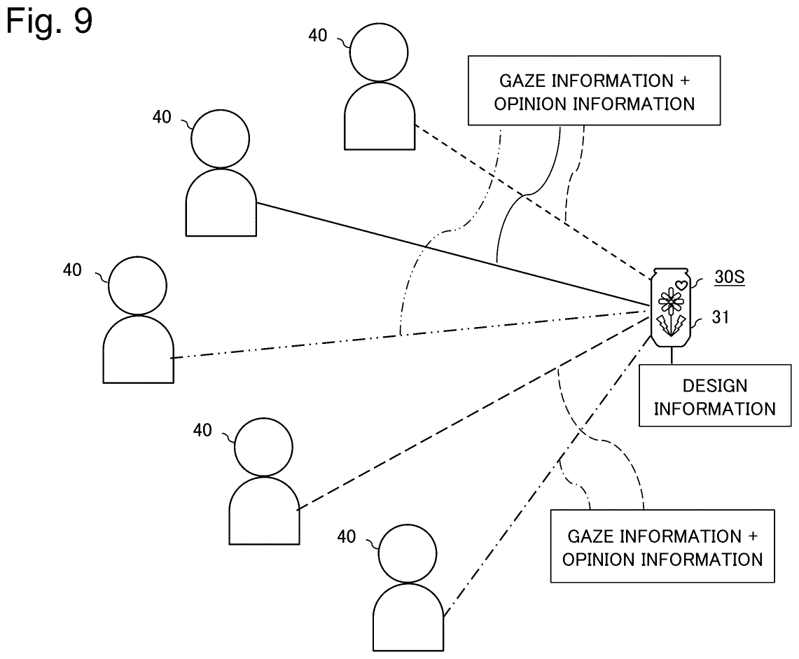

The classification unit 12 generates a graph as illustrated in FIG. 9 using the information acquired by the acquisition unit 11. The graph illustrated in FIG. 9 is a graph in which the gaze information and the opinion information are set as edges, and the design 31 of the target product 30S and the target persons (monitors 40) are set as nodes. The classification unit 12 uses the graph AI technology to generate feature vectors for the nodes and the edges in the graph generated using such opinion information as well, using the model 22.

The classification unit 12 classifies the target persons (monitors 40) into a plurality of clusters using the feature vectors for the nodes in the graph including the opinion information. Specific examples of the cluster include a cluster of target persons who have high intention to purchase and have focused on the key visual, and a cluster of target persons who have many comments on colors and have a long gaze fixing time on the nutritional information, in which the opinion information is reflected.

The configuration other than the above-described point in the support device 1 according to the second example embodiment is similar to the configuration of the support device 1 according to the first example embodiment.

Similarly to the first example embodiment, since the support device 1 according to the second example embodiment outputs the result of the classification obtained by classifying the plurality of target persons into the plurality of clusters using the gaze information in relation to the design 31 of the target product 30S, a similar effect to that of the support device 1 according to the first example embodiment is obtained. In addition, since the support device 1 according to the second example embodiment classifies the target persons by including the opinion information of the target persons on the design 31, it is possible to provide more effective information about how the design of the product looks and to suitably support preparation (generation) of the product design.

### Third Example Embodiment

Hereinbelow, a third example embodiment of the present invention will be described. Note that, in the description of the third example embodiment, the same reference signs are given to the same components as those of the product-design generation support device (support device) 1 according to the first or second example embodiment, and redundant description of the common components will be omitted.

The support device 1 according to the third example embodiment has not only the configuration of the support device 1 according to the first or second example embodiment but also a function in which the classification unit 12 estimates a reason for the classification of the target persons and the output unit 13 outputs the classification reason. That is, in the third example embodiment, the classification unit 12 not only classifies the plurality of target persons into the plurality of clusters based on the gaze information, but also estimates the classification reason, in relation to the design 31 of the target product 30S. As a method of estimating the classification reason, for example, the classification unit 12 uses a model for classification reason estimation. The model for classification reason estimation is a model that is stored in the storage device 20 or the storage device 25 and has learned a rule for classifying (clustering) a plurality of target persons into a plurality of clusters based on feature vectors of the target persons. In the third example embodiment, this model is used not for classification of the target persons but for estimation of the classification reason. That is, after classifying a plurality of target persons into a plurality of clusters by means of the models 22 and 23, the classification unit 12 estimates a rule for classifying the target persons in such a way as to obtain the classification result by means of the classification reason estimation model. Then, the classification unit 12 estimates the classification reason using the rule estimated by the classification reason estimation model. For example, as illustrated in FIG. 7, suppose that the target persons are classified into the plurality of clusters. Also, suppose that it is estimated by the rule estimation operation of the model based on the classification result that, for example, a rule of first looking at the key visual is included as one of the rules in which the target persons classified into a cluster A are classified into the cluster A. In such a case, the classification unit 12 estimates the reason why the target persons classified into the cluster A are classified into the cluster A to be, for example, the reason that the target persons have been strongly impacted by the key visual.

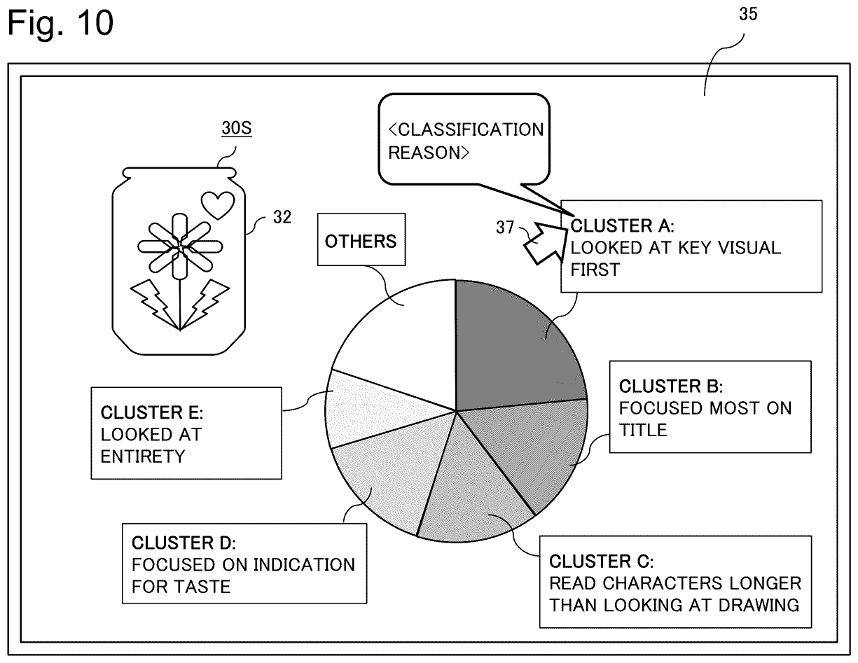

The output unit 13 outputs information about the classification reason estimated by the classification unit 12 in addition to the cluster information. The information about the classification reason includes, for example, the cluster identification information for identifying the related cluster. The information about the classification reason is transmitted to the terminal device 3, for example, and is displayed on the display device by the display control operation of the terminal device 3. FIG. 10 is a diagram illustrating a display example of the display device representing the classification reason. In the example of FIG. 10, on a screen 35 of the display device on which the cluster information is displayed, the classification reason regarding the cluster designated by a pointer 37 is popped up.

The configuration other than the above-described point in the support device 1 according to the third example embodiment is similar to the configuration of the support device 1 according to the first or second example embodiment.

Similarly to the first or second example embodiment, since the support device 1 according to the third example embodiment outputs the result of the classification obtained by classifying the plurality of target persons into the plurality of clusters using the gaze information in relation to the design 31 of the target product 30S, a similar effect to that of the support device 1 according to the first or second example embodiment is obtained. In addition, since the support device 1 according to the third example embodiment outputs the reason for the classification of the target persons, it is possible to provide information that facilitates interpretation of the cluster.

### Fourth Example Embodiment

Hereinbelow, a fourth example embodiment of the present invention will be described. Note that, in the description of the fourth example embodiment, the same reference signs are given to the same components as those of the product-design generation support device (support device) 1 according to any of the first to third example embodiments, and redundant description of the common components will be omitted.

The support device 1 according to the fourth example embodiment also uses person attribute information about the target persons (monitors 40) for the classification of the target persons. Examples of the person attribute information include age, lifestyle information (for example, information about a meal such as the number of meals and a meal time zone in one day, the amount of exercise in one week, sleeping hours, wake-up time, bed time, and commuting time), preference information, and a hobby. The person attribute information used by the support device 1 is appropriately set in consideration of the type of the target product and the like.

In the fourth example embodiment, the person attribute information is transmitted from the terminal device 3 to the support device 1, for example. The person attribute information can be acquired by a questionnaire in a survey such as a venue survey. Furthermore, in a case where the monitors 40 are, for example, persons selected from persons who have registered the above-described attribute information in advance, the person attribute information can be acquired from the registered information.

The acquisition unit 11 acquires the person attribute information as described above in addition to the information acquired in the first to third example embodiments.

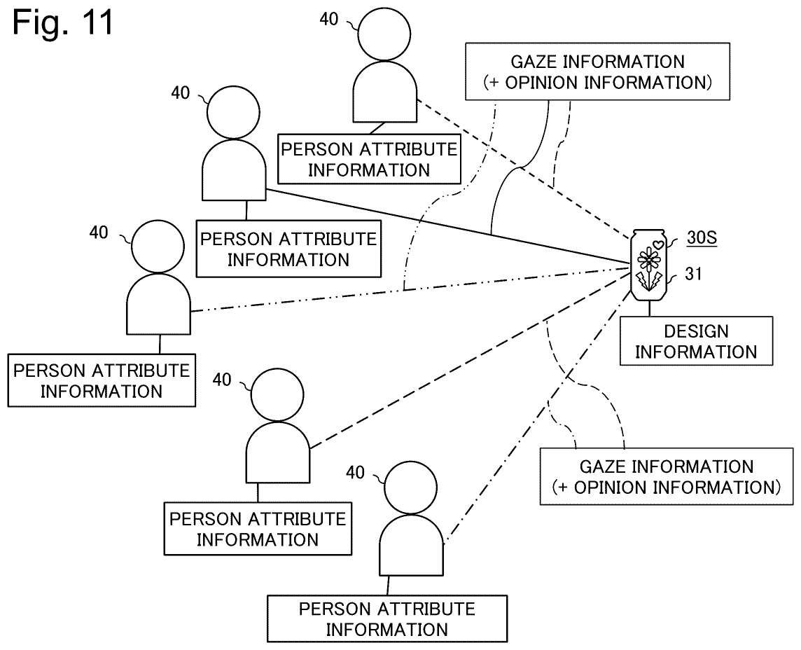

Similarly to the first to third example embodiments, the classification unit 12 generates a graph (knowledge graph) as illustrated in FIG. 11 and then generates feature vectors for nodes and edges in the graph. In the fourth example embodiment, the feature vectors include vector elements based on the person attribute information.

The classification unit 12 classifies the target persons (monitors 40) into a plurality of clusters using the feature vectors including the person attribute information. Specific examples of the cluster in the fourth example embodiment include a cluster of persons who drink alcohol at a frequency of about once a week and have focused on the title, and a cluster of persons who like sports and want to purchase at a glance, in which the person attribute information is reflected.

The configuration other than the above-described point in the support device 1 according to the fourth example embodiment is similar to the configuration of the support device 1 according to any of the first to third example embodiments.

Similarly to any of the first to third example embodiments, since the support device 1 according to the fourth example embodiment outputs the result of the classification obtained by classifying the plurality of target persons into the plurality of clusters using the gaze information in relation to the design 31 of the target product 30S, a similar effect to that of the support device 1 according to any of the first to third example embodiments is obtained. In addition, the support device 1 according to the fourth example embodiment generates clusters in which the person attribute information is reflected. Therefore, in a case where a group of persons to be paid attention to is determined at the time of preparing a product design, the product developer, the designer, or the like can easily acquire more effective information for preparing the design by referring to the information of the cluster related to the person attribute information related to the group of persons to be paid attention to.

### Other Example Embodiments

Note that the present invention is not limited to the first to fourth example embodiments, and various example embodiments can be adopted. For example, in the first to fourth example embodiments, the support device 1 is described, using the package design as an example of the product design, but the design for the target product that the support device 1 according to the first to fourth example embodiments targets is not limited to the package design. For example, the design for the target product the support device 1 according to the first to fourth example embodiments targets may be a design for an object to be housed in a package or a design for a product itself without a package.

Also, in the first to fourth example embodiments, an example is illustrated in which the gaze information and the opinion information of the target persons in relation to the target design for the target product are acquired in the venue survey. Alternatively, the gaze information and the opinion information of the target persons in relation to the target design for the target product may be acquired in, for example, a questionnaire survey on the street. In this case, each of the target persons is a person who answers the questionnaire on the street, and the gaze information of the target person can be acquired from a photographed image (or a shot moving image) obtained by photographing the target person answering the questionnaire by means of the photographing device in a similar manner to that described above. Further, in the first to fourth example embodiments, the gaze information in a case where the target person directly looks at the target product 30S and the opinion information obtained by the target person directly looking at the target product 30S are used. Alternatively, for example, gaze information in a case where the target person looks at the target product 30S included in an advertisement in a newspaper, a magazine, a television, or a website, or an advertisement in a public transportation facility, or opinion information obtained by the target person looking at the target product 30S included in such an advertisement may be used.

Further, the support device 1 according to the first to fourth example embodiments may construct a product-design generation support system together with the connected terminal device 3, for example.

Further, in the first to fourth example embodiments, the classification unit 12 classifies a plurality of target persons into a plurality of groups (clusters) using the model 23 for clustering. Alternatively, the classification unit 12 may classify the designs into a plurality of groups by means of another method such as a method of classifying the target persons using statistical processing, for example.

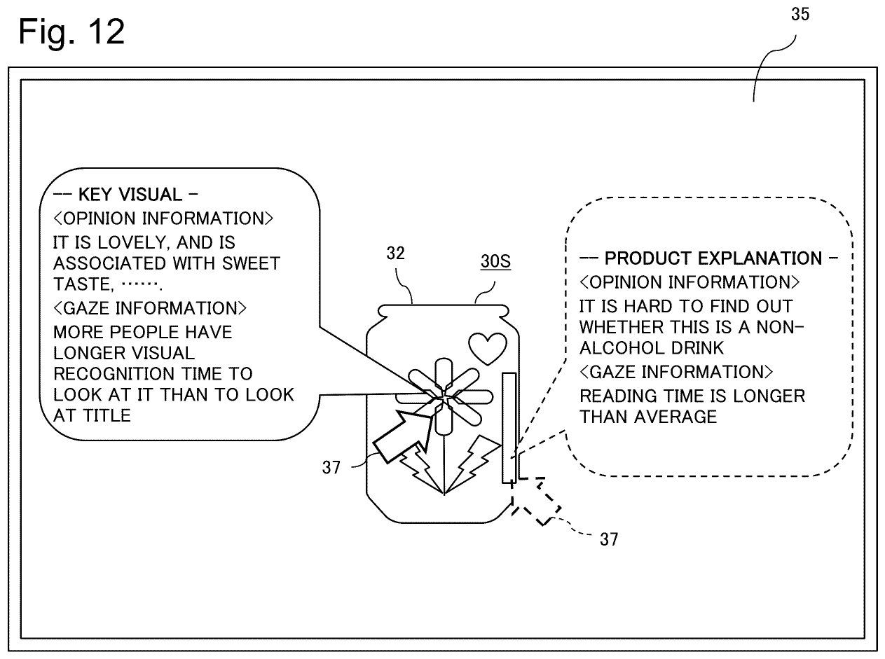

Further, in addition to the second to fourth example embodiments, the output unit 13 may output the opinion information and the gaze information in relation to the design of the target product 30S in a state of being able to be associated with the related design element. FIG. 12 illustrates a display example of the display device in a case where the opinion information and the gaze information are transmitted to the terminal device 3. In the example of FIG. 12, on the screen 35 of the display device on which the design image 32 of the target product 30S is displayed, the opinion information and the gaze information related to the design element designated by the pointer 37 are popped up. In the example of FIG. 12, both the opinion information and the gaze information are popped up, but the opinion information and the gaze information are acquired by the acquisition unit 11 and then transmitted to the terminal device 3. Therefore, depending on the acquisition status of the acquisition unit 11, one of the opinion information and the gaze information may not be displayed on the screen 35.

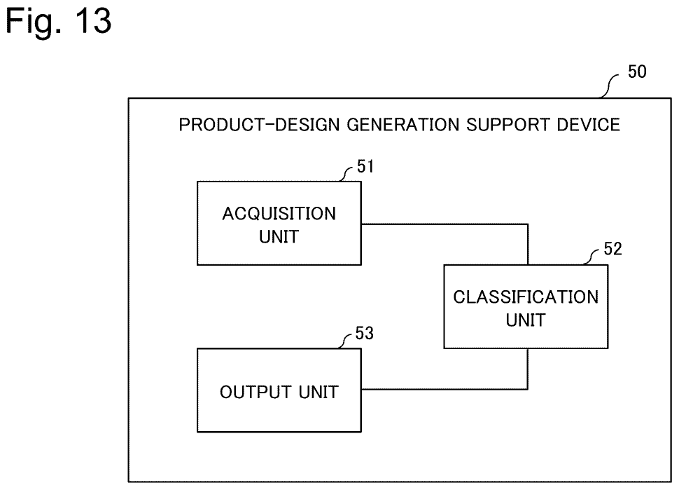

FIG. 13 is a block diagram illustrating a minimum configuration of a product-design generation support device. A product-design generation support device 50 includes an acquisition unit 51, a classification unit 52, and an output unit 53. The product-design generation support device 50 is, for example, a computer device, and as in the first to fourth example embodiments, the acquisition unit 51, the classification unit 52, and the output unit 53 are achieved.

The acquisition unit 51 acquires design information representing a target design for a target product, as well as gaze information of a plurality of target persons in relation to the target design. The classification unit 52 classifies the plurality of target persons into a plurality of groups based on the acquired design information and gaze information. The output unit 53 outputs the result of the classification.

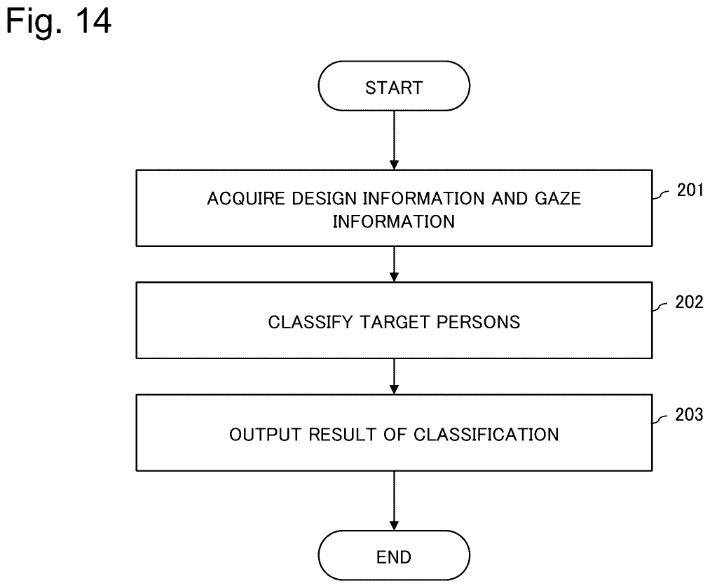

FIG. 14 is a flowchart illustrating an example of the operation of the product-design generation support device 50. For example, the acquisition unit 51 acquires design information representing a target design for a target product, as well as gaze information of a plurality of target persons in relation to the target design (step 201). Subsequently, the classification unit 52 classifies the plurality of target persons into a plurality of groups based on the acquired design information and gaze information (step 202). Then, the output unit 53 outputs the result of the classification (step 203).

With the configuration as described above, the product-design generation support device 50 achieves an effect of being able to generate and present information that is effective for preparing and determining a product design.

Some or all of the above example embodiments can be described as the following supplementary notes, but are not limited to the following supplementary notes.

(Supplementary Note 1)

A product-design generation support device including
an acquisition means that acquires design information representing a target design for a target product, as well as gaze information of a plurality of target persons in relation to the target design,
a classification means that classifies the plurality of target persons into a plurality of groups based on the design information and the gaze information acquired, and
an output means that outputs a result of the classification.

(Supplementary Note 2)

The product-design generation support device according to supplementary note 1, wherein the gaze information includes at least one of a gaze trajectory of each of the target persons in relation to the target design and a gaze fixing time of each of the target persons in relation to the target design.

(Supplementary Note 3)

The product-design generation support device according to supplementary note 1 or 2, wherein the acquisition means further acquires person attribute information about the target persons, and
wherein the classification means classifies the plurality of target persons based on the person attribute information as well.

(Supplementary Note 4)

The product-design generation support device according to any one of supplementary notes 1 to 3, wherein the acquisition means further acquires opinion information of the target persons on the target design, and
wherein the classification means classifies the plurality of target persons based on the opinion information as well.

(Supplementary Note 5)

The product-design generation support device according to any one of supplementary notes 1 to 4, wherein the classification means estimates a classification reason of the target persons based on the gaze information of the target persons in relation to the target design, and
wherein the output means further outputs the classification reason.

(Supplementary Note 6)

The product-design generation support device according to supplementary note 4, wherein the design information includes a design image representing the target design, and
wherein the output means further outputs the design image and the opinion information.

(Supplementary Note 7)

The product-design generation support device according to any one of supplementary notes 1 to 6, wherein the design information includes a design image representing the target design, and
wherein the output means further outputs the design image and the gaze information.

(Supplementary Note 8)

The product-design generation support device according to any one of supplementary notes 1 to 7, wherein the classification means classifies the plurality of target persons into the plurality of groups using a clustering model, and
wherein the clustering model is a model that classifies the plurality of target persons into the plurality of groups using feature values of the target persons based on the gaze information.

(Supplementary Note 9)

A product-design generation support system including
an acquisition means that acquires design information representing a target design for a target product, as well as gaze information of a plurality of target persons in relation to the target design,
a classification means that classifies the plurality of target persons into a plurality of groups based on the design information and the gaze information acquired, and
an output means that outputs a result of the classification.

(Supplementary Note 10)

A product-design generation support method including, by means of a computer,
acquiring design information representing a target design for a target product, as well as gaze information of a plurality of target persons in relation to the target design,
classifying the plurality of target persons into a plurality of groups based on the design information and the gaze information acquired, and outputting a result of the classification.

(Supplementary Note 11)

A program storage medium stores a computer program that causes a computer to execute
processing of acquiring design information representing a target design for a target product, as well as gaze information of a plurality of target persons in relation to the target design,
processing of classifying the plurality of target persons into a plurality of groups based on the design information and the gaze information acquired, and
processing of outputting a result of the classification.

The present invention has been particularly shown and described using the example embodiments as exemplary embodiments. However, the present invention is not limited to these example embodiments. That is, the present invention can be applied to various aspects that can be understood by those of ordinary skill in the art without departing from the spirit and scope of the present invention defined by the claims.

### REFERENCE SIGNS LIST

1, 50 product-design generation support device
11, 51 acquisition unit
12, 52 classification unit
13, 53 output unit

What is claimed is:

1. A product-design generation support device comprising:
a memory configured to store instructions; and
a processor configured to execute the instructions to:
acquire design information representing a target design for a target product, as well as gaze information of a plurality of target persons in relation to the target design;
classify the plurality of target persons into a plurality of groups based on the design information and the gaze information acquired; and
output a result of the classification.

2. The product-design generation support device according to claim 1, wherein the gaze information includes at least one of a gaze trajectory of each of the target persons in relation to the target design and a gaze fixing time of each of the target persons in relation to the target design.

3. The product-design generation support device according to claim 1, wherein the processor is configured to acquire further person attribute information about the target persons, and
wherein the processor is configured to classify the plurality of target persons based on the person attribute information as well.

4. The product-design generation support device according to claim 1, wherein the processor is configured to acquire further acquires opinion information of the target persons on the target design, and
wherein the processor is configured to classify the plurality of target persons based on the opinion information as well.

5. The product-design generation support device according to claim 1, wherein the processor is further configured to estimate a classification reason of the target persons based on the gaze information of the target persons in relation to the target design, and
wherein the processor is configured to output further outputs the classification reason.

6. The product-design generation support device according to claim 4, wherein the design information includes a design image representing the target design, and
wherein the processor is configured to output further the design image and the opinion information.

7. The product-design generation support device according to claim 1, wherein the design information includes a design image representing the target design, and
wherein the processor is configured to output further the design image and the gaze information.

8. The product-design generation support device according to claim 1, wherein the processor is configured to classify the plurality of target persons into the plurality of groups using a clustering model, and
wherein the clustering model is a model that classifies the plurality of target persons into the plurality of groups using feature values of the target persons based on the gaze information.

9. (canceled)

10. A product-design generation support method comprising, by means of a computer:
acquiring design information representing a target design for a target product, as well as gaze information of a plurality of target persons in relation to the target design;
classifying the plurality of target persons into a plurality of groups based on the design information and the gaze information acquired; and
outputting a result of the classification.

11. A non-transitory computer readable medium stores a computer program that causes a computer to execute:
processing of acquiring design information representing a target design for a target product, as well as gaze information of a plurality of target persons in relation to the target design;
processing of classifying the plurality of target persons into a plurality of groups based on the design information and the gaze information acquired; and
processing of outputting a result of the classification.
